(19) United States
(12) Patent Application Publication
(10) Pub. No.: US 2023/0312393 A1
(43) Pub. Date: Oct. 5, 2023

(54) TEMPERED GLASS

(71) Applicant: NIPPON ELECTRIC GLASS CO., LTD., Otsu-shi, Shiga (JP)

(72) Inventors: Kosuke KAWAMOTO, Otsu-shi, Shiga (JP); Kiyotaka KINOSHITA, Otsu-shi, Shiga (JP); Yuta NAGANO, Otsu-shi, Shiga (JP); Hiroshi SASAKI, Otsu-shi, Shiga (JP)

(73) Assignee: NIPPON ELECTRIC GLASS CO., LTD., Otsu-shi, Shiga (JP)

(21) Appl. No.: 18/021,191

(22) PCT Filed: Sep. 14, 2021
(86) PCT No.: PCT/JP2021/033697

§ 371 Date: Feb. 14, 2023

(30) Foreign Application Priority Data
Sep. 24, 2020 (JP) 2020-159873
Dec. 9, 2020 (JP) 2020-203906

(51) Int. Cl. C03C 3/083; C03C 21/00; C03C 3/091

(52) U.S. Cl. CPC C03C 3/083; C03C 21/002; C03C 3/091

(57) ABSTRACT

There is provided a tempered glass having an extremely small thickness, high strength, and high safety as compared to the related art. A plate-shaped or sheet-shaped tempered glass includes: a compression stress layer on a surface thereof; and a tensile stress layer on an inner side in a thickness direction of the glass with respect to the compression stress layer, and includes at least partially a thin portion having a thickness t1 and being bendable, the thickness t1 is 105 μm or less, a depth DOC of the compression stress layer is 9.0 μm or less, and CS/DOC≥95 is satisfied.

### TECHNICAL FIELD

The present invention relates to a tempered glass, particularly to a chemically tempered glass having a small thickness.

### BACKGROUND ART

In recent years, a chemically tempered glass having a thickness of approximately 0.4 to 1.0 mm is often used as a cover glass for various types of electronic terminals and display devices. In particular, for the use in a portable electronic terminal such as a non-bending type (so-called straight type) smartphone, it is considered that the glass is required to have a depth of a compression stress layer of at least 15 μm or greater so as to ensure strength of the cover glass (e.g., Patent Document 1).

### CITATION LIST

### Patent Literature

Patent Document 1: JP 2016-102060 A

### SUMMARY OF INVENTION

### Technical Problem

In recent years, there has been developed a device such as a so-called foldable smartphone or tablet PC in which the display surface of a display can be folded. It has been examined that a cover glass used for such a device has a smaller thickness than that in the related art, and for example, has an extremely thin dimension of 105 μm (i.e., 0.105 mm) or less. In a glass for such a foldable-type application, required characteristics are different from those of a glass for the straight-type device application in the related art. In a thin glass for such an application, when DOC is designed to be deep for achieving a deep tempered layer as in a glass in the related art and CS is increased, there is a concern that an internal stress becomes excessive in the small thickness, leading to self-destruction or explosive crushing of the glass at the time of destruction. That is, there is room for improvement in design such as stress characteristics in the thin, chemically tempered glass having a thickness of 105 μm or less.

The present invention is directed to providing a tempered glass having an extremely small thickness, high strength, and high safety.

### Solution to Problem

A tempered glass according to the present invention is a tempered glass having a plate shape or a sheet shape and including: a compression stress layer on a surface of the tempered glass; and a tensile stress layer on an inner side in a thickness direction of the glass with respect to the compression stress layer, in which the tempered glass includes at least partially a thin portion having a thickness t1 and being bendable, the thickness t1 is 105 μm or less, a depth DOC of the compression stress layer is 9.0 μm or less, and when a maximum compression stress of the compression stress layer is defined as CS, CS/DOC≥95 is satisfied.

Preferably, the tempered glass according to the present invention has the thickness t1 of 20 μm or greater and 95 μm or less, the maximum compression stress CS in the compression stress layer is 550 MPa or greater and 1600 MPa or less, and the depth DOC of the compression stress layer is 1.0 μm or greater and 8.5 μm or less.

Preferably, in the tempered glass according to the present invention, the maximum compression stress CS in the compression stress layer and the depth DOC of the compression stress layer satisfy CS/DOC≥110.

Preferably, the tempered glass according to the present invention has a tensile stress CT of 95 MPa or less.

Preferably, the tempered glass according to the present invention satisfies DOC/t1≤0.09, where DOC/t1 is a ratio of the depth DOC of the compression stress layer to the thickness t1.

Preferably, in the tempered glass according to the present invention, the tensile stress layer includes a first region extending from the depth DOC of the compression stress layer to a tensile stress convergence depth DCT, in which a tensile stress varies in the thickness direction of the glass, and a second region extending to a deeper region than the tensile stress convergence depth DCT, in which the tensile stress is constant in the thickness direction, the tensile stress convergence depth DCT is 10.0 μm or less, and DCT/t1≤0.10 is satisfied.

Preferably, the tempered glass according to the present invention includes a plurality of thick portions having a thickness t2 greater than the thickness t1 of the thin portion, the thickness t2 is 110 μm or greater and 300 μm or less, and the thin portion extends in a band shape to connect the plurality of thick portions.

Preferably, in the tempered glass according to the present invention, a band width of the thin portion is 3 mm or greater.

Preferably, the tempered glass according to the present invention is entirely constituted by the thin portion, and has a substantially uniform thickness.

Preferably, the tempered glass according to the present invention contains, as a glass composition, in mol %, from 50 to 80% of SiO₂, from 5 to 20% of Al₂O₃, from 0 to 15% of B₂O₃, from 0 to 20% of Li₂O, from 1 to 20% of Na₂O, and from 0 to 10% of K₂O.

Preferably, the tempered glass according to the present invention contains, as the glass composition, in mol %, from 50 to 80% of SiO₂, from 5 to 25% of Al₂O₃, from 0 to 1% of B₂O₃, from 0 to 20% of Li₂O, from 1 to 20% of Na₂O, and from 0 to 10% of K₂O.

Preferably, the tempered glass according to the present invention contains, as the glass composition, in mol %, from 50 to 80% SiO₂, from 5 to 25% of Al₂O₃, from 1 to 5% of B₂O₃, from 0 to 20% of Li₂O, from 1 to 20% of Na₂O, and from 0 to 10% of K₂O.

Preferably, the tempered glass according to the present invention contains, as the glass composition, in mol %, from 50 to 80% of SiO₂, from 5 to 10% of Al₂O₃, from 1 to 5% of B₂O₃, from 0 to 20% of Li₂O, from 1 to 20% of Na₂O, and from 0 to 10% of K₂O.

Preferably, the tempered glass according to the present invention includes an entire surface constituted by an etched surface.

In another aspect, a tempered glass according to the present invention is a tempered glass having a plate shape or a sheet shape and including: a compression stress layer on a surface of the tempered glass; and a tensile stress layer on an inner side in a thickness direction of the glass with respect to the compression stress layer, in which the tempered glass includes at least partially a thin portion having a thickness t1 and being bendable, the thickness t1 is 105 μm or less, a depth DOC of the compression stress layer is 9.0 μm or less, and when a maximum compression stress of the compression stress layer is defined as CS, CS/DOC≥110 is satisfied.

### Advantageous Effects of Invention

According to the present invention, it is possible to provide a tempered glass having an extremely small thickness, high strength, and high safety, as compared to the related art.

### BRIEF DESCRIPTION OF DRAWINGS

FIG. 1 is a schematic plan view of a tempered glass according to a first embodiment of the present invention, as viewed in a thickness direction;

FIG. 2 is a schematic cross-sectional view of the tempered glass according to the first embodiment of the present invention;

FIG. 3 is a conceptual diagram of stress distribution in the thickness direction of the tempered glass according to the first embodiment of the present invention; and

FIG. 4 is a schematic cross-sectional view of a tempered glass according to a second embodiment of the present invention.

### DESCRIPTION OF EMBODIMENTS

### First Embodiment

Hereinafter, a tempered glass according to a first embodiment of the present invention will be described.

### Tempered Glass

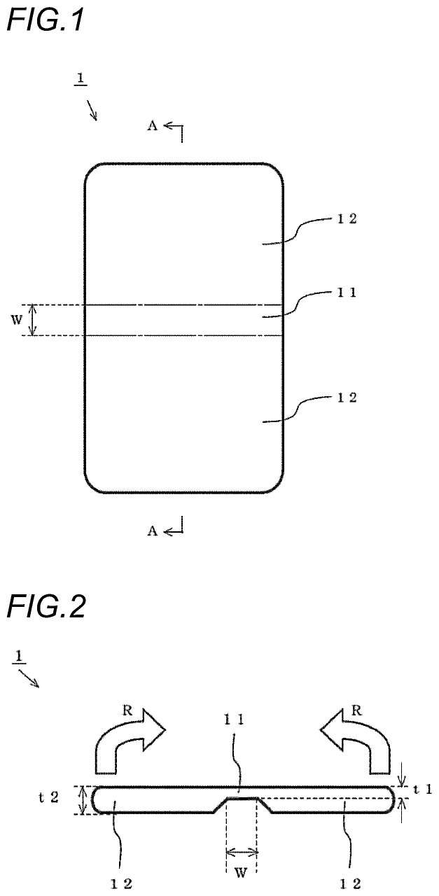

FIG. 1 is a schematic plan view of a tempered glass 1 according to the first embodiment of the present invention, as viewed in a thickness direction. FIG. 2 is a schematic cross-sectional view taken along AA of FIG. 1. As illustrated in FIGS. 1 and 2, the tempered glass 1 is a chemically tempered glass having a plate or sheet shape.

In the present embodiment, as illustrated in FIG. 1, a case where the tempered glass 1 has a rectangular shape having long sides and short sides in a plan view is taken as an example. The length of the long side of the tempered glass 1 is, for example, 50 mm or greater and 500 mm or less, preferably 60 mm or greater and 450 mm or less, more preferably 65 mm or greater and 400 mm or less, and still more preferably 70 mm or greater and 300 mm or less, 75 mm or greater and 200 mm or less, or 80 mm or greater and 160 mm or less. The length of the short side is, for example, 40 mm or greater and 400 mm or less, preferably 45 mm or greater and 350 mm or less, more preferably 50 mm or greater and 300 mm or less, and still more preferably 55 mm or greater and 120 mm or less, or 60 mm or greater and 80 mm or less.

The tempered glass 1 has at least partially a bendable thin portion 11. “Bendable” in the present invention refers to having flexibility that a minimum bending radius is 10 mm or less without breaking at the time of bending.

The tempered glass 1 includes a thick portion 12 having a relatively larger thickness than the thin portion 11.

The thin portion 11 is provided in such a manner to define two thick portions 12 and couple the two thick portions 12. In other words, the thin portion 11 extends in a band-shaped manner from one end to the other end of the tempered glass 1. More specifically, the thin portion 11 is provided parallel to the short side to traverse the main surface of the tempered glass 1 from the central portion of one long side to the central portion of the other long side.

The two thick portions 12 are preferably shaped to be axisymmetric with each other with respect to the thin portion 11. According to such a configuration, the tempered glass 1 can be bent in such a manner that the two thick portions 12b overlap each other, which is suitable for applications such as a foldable device.

A thickness t1 of the thin portion 11 is 105 μm or less, preferably 10 μm or greater and 95 μm or less, preferably 20 μm or greater and 85 μm or less, and more preferably 30 μm or greater and 75 μm or less. The thickness t1 can be 65 μm or less, or 55 μm or less, in response to a further thinning requirement. On the other hand, a suitable lower limit range of the thickness t1 is preferably 40 μm or greater, or 50 μm or greater. When the glass is too thin, it is difficult to ensure strength, and when the glass is excessively thin, it is difficult to increase a compression stress value of the surface, which may impair flexibility. The thickness of the thin portion 11 is preferably constant, but in a case where the thickness is not constant, t1 can be determined as the thickness of the thinnest site of the thin portion 11.

A width W of the thin portion 11 is, for example, 3 mm or greater and 50 mm or less, and preferably 5 mm or greater and 30 mm or less. The width of the thin portion 11 is preferably constant. When the width W is set to be within such a range, a motion range required for bending can be sufficiently ensured.

A thickness t2 of the thick portion 12 is, for example, 110 μm or greater, preferably more than 120 μm and 300 μm or less, more preferably 150 μm or greater and 270 μm or less, and still more preferably 170 μm or greater and 250 μm or less. The thickness t2 of the thick portion 12 is preferably constant. When the thickness t2 of the thick portion 12 is set to be within such a range, deformability of the thick portion 12 can be appropriately suppressed, which can improve handleability during assembling and manufacturing of a device.

In the present embodiment, a recessed groove portion is formed on one main surface side of the tempered glass 1, and the remaining portion on the other main surface side constitutes the thin portion 11. The tempered glass 1 can be bendable, for example, in a direction where the recessed groove portion side is an outer side (an arrow R direction in FIG. 2). When the tempered glass 1 is bendable in such a direction, a flat surface without the recessed groove portion can be a touch surface of a foldable device, so that it is possible to protect the touch surface at the time of folding the foldable device.

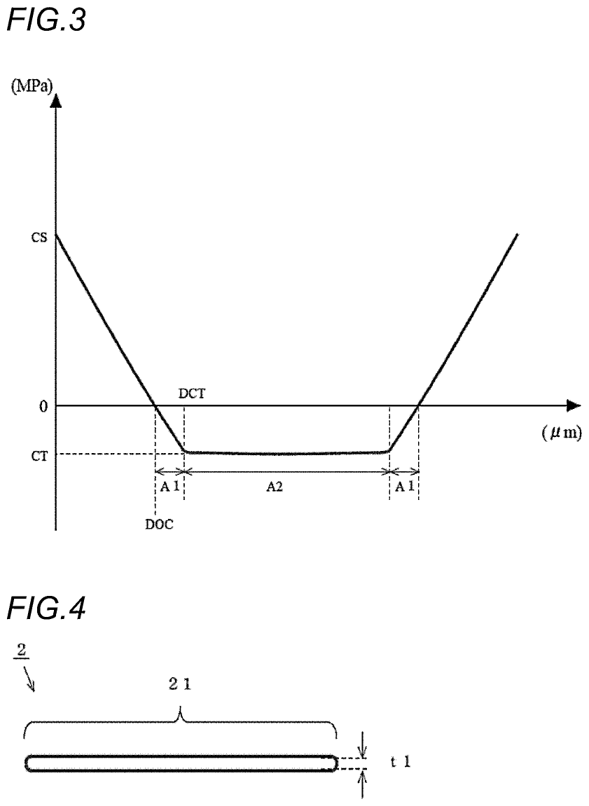

The tempered glass 1 includes a compression stress layer on the surface thereof, and a tensile stress layer on an inner side (a central side in the plate thickness direction) with respect to the compression stress layer. An example of stress distribution of the tempered glass 1 is shown in FIG. 3. In FIG. 3, the vertical axis indicates a stress value, and the horizontal axis indicates a depth from the surface. In the vertical axis of FIG. 3, a positive value indicates a compression stress, and a negative value indicates a tensile stress. Note that, unless otherwise noted herein, a magnitude of each stress is indicated by an absolute value.

The stress distribution shown in FIG. 3 exemplifies a case where the tempered glass 1 is a glass subjected to one-step ion exchange treatment. In the stress distribution of the tempered glass 1, the compression stress is maximum (maximum compression stress CS) on the surface, the stress gradually decreases as the depth from the surface increases, and the stress is zero at the depth DOC. That is, DOC is synonymous with the depth of compression stress. The tensile stress layer having a tensile stress extends in a region deeper than the depth DOC. The compression stress distribution of the tempered glass 1 is preferably front-back symmetrical as shown in FIG. 3.

The tensile stress layer includes a first region A1 in which the tensile stress varies in the thickness direction of the glass, and a second region A2 in which the tensile stress is constant in the thickness direction. More specifically, the first region A1 is a region extending from the depth DOC of the compression stress layer to a tensile stress convergence depth DCT, in which an absolute value of the tensile stress gradually increases (gradually decreases in representation in negative numerals shown in FIG. 3) as the depth increases. The second region A2 is a region extending in a region deeper than the tensile stress convergence depth DCT, in which the tensile stress is constant in the thickness direction. Note that in the present invention, the expression that the “tensile stress is constant” refers to that an amount of change in stress in the depth direction is 0.5 MPa/μm or less, and the amount of change can be calculated, for example, by a differential value of stress sampled at an interval of a depth of 0.1 μm.

The depth DOC of the compression stress layer of the tempered glass 1 is 9.0 μm or less, preferably 1 μm or greater and 8.5 μm or less, more preferably 2 μm or greater and 8.0 μm or less, and more preferably 2.5 μm or greater and 7.5 μm or less, or 2.5 μm or greater and 5.5 μm or less. The inventors have conducted various studies on threshold values of the compression stress value of the surface and the depth of the compression stress layer for not leading to a hazardous fracture mode at the time of fracturing. As a result, it has been found that the depth of the compression stress layer of 9.0 μm or less is effective in a thin glass of 105 μm or less as in the present invention. In this way, it is possible to ensure safety while having sufficient strength against bending.

The maximum compression stress CS of the compression stress layer of the tempered glass 1 can be, for example, 520 MPa or greater and 2000 MPa or less, preferably 600 MPa or greater and 1800 MPa or less, and more preferably 650 MPa or greater and 1800 MPa or less, 650 MPa or greater and 1700 MPa or less, or 700 MPa or greater and 1700 MPa or less. When CS is set to the range described above, high bending strength can be achieved. Note that for further improving the bending strength, the maximum compression stress CS can be more preferably 670 MPa or greater and 1600 MPa or less, still more preferably 760 MPa or greater and 1600 MPa or less, 820 MPa or greater and 1550 MPa or less, or 700 MPa or greater and 1550 MPa or less. On the other hand, in a case where crushing suppression at the time of fracturing is emphasized, and suppression of the maximum tensile stress CT is prioritized, the upper limit value of the maximum compression stress CS can be limited to 1000 MPa or less, 900 MPa or less, 800 MPa or less, 750 MPa or less, or 740 MPa or less.

In the first region A1, the tensile stress changes linearly, a value CS/DOC (MPa/μm) obtained by dividing the maximum compression stress value CS of the surface by the compression stress layer depth DOC, which is a gradient of the tensile stress, satisfies the following expression (1).

CS/DOC≥95 (1)

The inventors have conducted various studies on threshold values of the compression stress value of the surface and the depth of the compression stress layer for not leading to a hazardous fracture mode at the time of fracturing while ensuring sufficient bending strength. As a result, it has been found that it is effective that the value obtained by dividing the compression stress value of the surface by the compression stress layer depth is 95.0 MPa/μm or greater. The lower limit value of CS/DOC is 95 MPa/μm or greater, preferably 97 MPa/μm or greater, 100 MPa/μm or greater, 105 MPa/μm or greater, 110 MPa/μm or greater, 120 MPa/μm or greater, 130 MPa/μm or greater, 140 MPa/μm or greater, or 145 MPa/μm or greater, and the upper limit value is, for example, 300 MPa/μm or less, and preferably 250 MPa/μm or less, or 200 MPa/μm or less. When CS/DOC is set to be within the numerical range described above, it is possible to control the depth of the compression stress layer that can ensure safety while achieving the compression stress value of the surface that has sufficient strength against bending in a thin glass of 105 μm or less.

The depth DOC of the compression stress layer and the thickness t1 of the thin portion 11 satisfy the following expression (2).

DOC/t1≤0.09 (2)

When the ratio of DOC to t1 is limited to the above range, safety can also be ensured while having sufficient strength against bending. The upper limit value of DOC/t1 is preferably 0.085 or less and more preferably 0.08 or less, and the lower limit value is preferably 0.03 or greater and more preferably 0.04 or greater.

The tensile stress convergence depth DCT can be calculated by the following equation (3).

DCT=(CS+CT)/(CS/DOC) (3)

The tensile stress convergence depth DCT and the thickness t1 of the thin portion 11 satisfy the following expression (4).

DCT/t1≤0.10 (4)

When the ratio of DCT to t1 is limited to the range described above, safety can also be ensured while having sufficient strength against bending. The upper limit value of DCT/t1 is preferably 0.10 or less, and more preferably 0.09 or less, or 0.08 or less, and the lower limit value is preferably 0.03 or greater, and more preferably 0.04 or greater.

The upper limit value of the tensile stress convergence depth DCT is, for example, 10.0 μm or less, preferably 9.5 μm or less, and more preferably 9.0 μm or less, or 8.5 μm or less, and the lower limit value is, for example, 2.5 μm or greater, and preferably 3.0 μm or greater, 3.5 μm or greater, or 4.0 μm or greater.

The upper limit value of the maximum tensile stress CT of the second region A2 in the thin portion 11 is, for example, 1000 MPa or less, preferably 500 MPa or less, more preferably 400 MPa or less, and still more preferably 285 MPa or less, 250 MPa or less, 240 MPa or less, 230 MPa or less, 220 MPa or less, 210 MPa or less, 200 MPa or less, 190 MPa or less, 180 MPa or less, 170 MPa or less, 160 MPa or less, 150 MPa or less, 145 MPa or less, 140 MPa or less, 130 MPa or less, 120 MPa or less, 110 MPa or less, 100 MPa or less, 95 MPa or less, 85 MPa or less, or 70 MPa or less, and the lower limit value is preferably 20 MPa or greater, 50 MPa or greater, 55 MPa or greater, and more preferably 60 MPa or greater. When CT is limited as described above, it is possible to ensure the strength against bending while ensuring safety for not leading to a hazardous fracture mode at the time of fracturing.

Note that the numerical values related to stress such as CS, DOC, DCT, and CT in the present invention can be derived, for example, by measuring the stress distribution of the glass using measuring devices such as FSM-6000 or SLP-1000 available from Orihara Industrial Co., Ltd.

The Young's modulus of the tempered glass 1 is preferably 60 GPa or greater, and more preferably 65 GPa or greater, 70 GPa or greater, 75 GPa or greater, and 90 GPa or less.

The entire surface of the tempered glass 1, that is, both main surfaces including the thin portion 11 and an end surface, is preferably constituted by an etched surface. When the entire surface is etched, defects across the entire surface are reduced, so that high strength is ensured.

As a method for forming the tempered glass 1 into a sheet shape, an overflow downdraw method is suitable from the perspective of cost and amount of production, but when the sheet is thinned, the glass is quenched, so that CS tends to be low and DOC tends to be deep. It is also known that when a thin glass is ion-exchanged, an amount of the inner glass for suppressing volume expansion of an ion exchange portion is small, and thus a high CS is less likely to be obtained as compared to a thick glass. For a thin glass such as the tempered glass of the present invention, achieving both a high CS and a shallow DOC at a high level is not easy beyond just a design matter. That is, it is necessary to appropriately select a glass composition, a glass forming method, and tempering conditions. Thus, as the tempered glass 1, an alkali aluminosilicate glass suitable for chemical tempering is suitable, and among the alkali aluminosilicate glasses, a composition with which a high surface compression stress value can be obtained is particularly suitable. Further, a composition balance with which a high liquidus viscosity is achieved to enable forming by the overflow downdraw method is preferable. The tempered glass 1 contains, for example, as a glass composition, in mol %, from 50 to 80% of SiO₂, from 5 to 25% of Al₂O₃, from 0 to 35% of B₂O₃, from 0 to 20% of Li₂O, from 1 to 20% of Na₂O, from 1 to 20% of Li₂O+Na₂O, and from 0 to 10% of K₂O.

SiO₂ is a component that forms the network of the glass. When the content of SiO₂ is too small, vitrification is difficult, and a thermal expansion coefficient is too high, and thus the thermal shock resistance is likely to decrease. Thus, the suitable lower limit range of SiO₂ is 50% or more, 55% or more, 57% or more, 59% or more, and in particular 61% or more, in mol %. On the other hand, when the content of SiO₂ is too large, meltability and formability are likely to decrease, the thermal expansion coefficient is too low, and thus it is difficult to match the thermal expansion coefficient of the peripheral material. Thus, the suitable upper limit range of SiO₂ is 80% or less, 70% or less, 68% or less, 66% or less, 65% or less, and in particular 64.5% or less.

Al₂O₃ is a component that enhances ion exchange performance, and is also a component that increases a strain point, Young's modulus, fracture toughness, and Vickers hardness. Thus, the suitable lower limit range of Al₂O₃ is 5% or more, 8% or more, 10% or more, 11% or more, or 11.2% or more, in mol %. On the other hand, when the content of Al₂O₃ is too large, a viscosity in high temperature increases, and thus the meltability and formability are likely to decrease. In addition, devitrified crystals are likely to be precipitated in the glass, and thus it is difficult to form the glass into a plate shape using the overflow downdraw method or the like. In particular, when an alumina-based refractory is used as a compact refractory to form the glass sheet using the overflow downdraw method, devitrified crystals of spinel are likely to be precipitated at the interface with the alumina-based refractory. Furthermore, oxidation resistance also decreases, and thus it is difficult to be applied to an acid treatment process. Thus, the suitable upper limit range of Al₂O₃ is 25% or less, 21% or less, 20.5% or less, 20% or less, 19.9% or less, 19.5% or less, 19.0% or less, and in particular 18.9% or less. When the content of Al₂O₃ that has a large influence on the ion exchange performance is within the suitable range, it is easy to design CS/DOC to a high value even in a thin glass of 105 μm or less.

B₂O₃ is a component that lowers the viscosity in high temperature and density, stabilizes the glass to make it difficult for crystals to be precipitated, and lowers a liquidus temperature. It is also a component that reduces the Young's modulus and enhances bending strength and crack resistance. However, when the content of B₂O₃ is too large, there are tendencies that coloring of the surface, which is referred to as stain, is generated due to the ion exchange treatment, the water resistance decreases, and the compression stress value of the compression stress layer decreases. Thus, the suitable lower limit range of B₂O₃ is 0% or more, 0.01% or more, 0.02% or more, 0.1% or more, or 0.3% or more, and the suitable upper limit range is 35% or less, 30% or less, 25% or less, 22% or less, 20% or less, and in particular 15% or less, in mol %. Note that from the perspective of giving priority to increase of CS, the content of B₂O₃ can be further preferably from 0.2 to 5%, or from 0.3 to 1%. Alternatively, from the perspective of improving chemical durability for the purpose of defect suppression at the time of etching or the like, the upper limit range of the content of B₂O₃ can be preferably 1% or more, 1.5% or more, or 2% or more, and the lower limit range can be 5% or less, 4.5% or less, 4% or less, or 3% or less. On the other hand, from the perspective of giving priority to suppression of the Young's modulus, the content of B₂O₃ can be further preferably from 10 to 25%, from 15 to 23%, or from 18 to 22%.

Li₂O is an ion exchange component, and in particular, a component for providing a high surface compression stress value by ion-exchanging Li ions included in the glass and K ions in a molten salt. Li₂O is also a component that lowers the viscosity in high temperature to enhance meltability and formability. Thus, the suitable lower limit range of Li₂O is 3% or more, 4% or more, 4.2% or more, 5% or more, 5.5% or more, 6.5% or more, 7% or more, 7.3% or more, 7.5% or more, 7.8% or more, and in particular 8% or more, in mol %. Thus, the suitable upper limit range of Li₂O is 20% or less, 15% or less, 13% or less, 12% or less, 11.5% or less, 11% or less, 10.5% or less, less than 10%, and in particular 9.9% or less, 9% or less, or 8.9% or less.

Na₂O is an ion exchange component, and is also a component that lowers the viscosity in high temperature to enhance meltability and formability. Na₂O is also a component that improves devitrification resistance, and devitrification due to reaction with a compact refractory, in particular, an alumina refractory. When the content of Na₂O is too small, the meltability decreases, the thermal expansion coefficient excessively decreases, and an ion exchange rate is likely to decrease. Thus, the suitable lower limit range of Na₂O is 5% or more, 7% or more, 8% or more, 8.5% or more, 9% or more, 9.5% or more, 10% or more, 11% or more, 12% or more, and in particular 12.5% or more, in mol %. On the other hand, when the content of Na₂O is too large, the viscosity at which phase separation occurs is likely to decrease. In addition, the oxidation resistance is reduced, and the component balance of the glass composition is lacked, and thus the devitrification resistance may be reduced. Thus, the suitable upper limit range of Na₂O is 20% or less, 19.5% or less, 19% or less, 18% or less, 17% or less, 16.5% or less, 16% or less, 15.5% or less, and in particular 15% or less.

K₂O is a component that lowers the viscosity in high temperature and enhances the meltability and formability. It is also a component that improves the devitrification resistance and increases the Vickers hardness. However, when the content of K₂O is too large, the viscosity at which phase separation occurs is likely to decrease. Furthermore, the oxidation resistance is reduced, and the component balance of the glass composition is lacked, and thus the devitrification resistance tends to decrease. Thus, the suitable lower limit range of K₂O is 0% or more, 0.01% or more, 0.02% or more, 0.1% or more, 0.5% or more, 1% or more, 1.5% or more, 2% or more, 2.5% or more, 3% or more, and in particular 3.5% or more, and the suitable upper limit range is 10% or less, 5.5% or less, 5% or less, and in particular less than 4.5%, in mol %.

Li₂O and Na₂O are each a component that provides a high surface compression stress value by ion exchange with K ions in the molten salt, and either Li₂O or Na₂O is an essential component of the present invention. Thus, the suitable lower limit range of Li₂O+Na₂O is 1% or more, 3% or more, 4% or more, 5% or more, 6% or more, 7% or more, 8% or more, 9% or more, 10% or more, 11% or more, 12% or more, 13% or more, 14% or more, 15% or more, 16% or more, 17% or more, 18% or more, and in particular 18.5% or more, in mol %. On the other hand, when the content of Li₂O+Na₂O is too large, the thermal expansion coefficient is too high, and thus the thermal shock resistance is likely to decrease. In addition, the component balance of the glass composition is lacked, and thus the devitrification resistance may be reduced. Thus, the suitable upper limit range of Li₂O+Na₂O is 20% or less, and in particular 19% or less.

In addition to the above components, the tempered glass 1 may contain, for example, the following components as the glass composition.

MgO is a component that lowers the viscosity in high temperature to increase the meltability and formability, and enhances the strain point and Young's modulus, and is a component that has a large effect on enhancing the ion exchange performance, among alkaline earth metal oxides. However, when the content of MgO is too large, the density and thermal expansion coefficient are likely to be high, and the glass is likely to be devitrified. Thus, the suitable upper limit range of MgO is 12% or less, 10% or less, 8% or less, 6% or less, and in particular 5% or less. Note that when MgO is introduced into the glass composition, the suitable lower limit range of MgO is 0.1% or more, 0.5% or more, 1% or more, and in particular 2% or more, in mol %.

CaO has large effects on reducing the viscosity in high temperature to enhance the meltability and formability without reducing the devitrification resistance, and on enhancing the strain point and Young's modulus, as compared to other components. The content of CaO is preferably from 0 to 10%. However, when the content of CaO is too large, the density and thermal expansion coefficient increase, and the component balance of the glass composition is lacked, and thus the glass is likely to be devitrified, and the ion exchange performance is likely to be reduced. Thus, the suitable content of CaO is from 0 to 5%, from 0.01 to 4%, from 0.1 to 3%, and in particular from 1 to 2.5%, in mol %.

SrO is a component that reduces the viscosity in high temperature to enhance the meltability and formability without reducing the devitrification resistance, and enhances the strain point and Young's modulus. However, when the content of SrO is too large, the density and thermal expansion coefficient increase, the ion exchange performance is reduced, and the component balance of the glass composition is lacked, and thus the glass is likely to be devitrified. The suitable content range of SrO is from 0 to 5%, from 0 to 3%, from 0 to 1%, and in particular from 0 to less than 0.1%, in mol %.

BaO is a component that reduces the viscosity in high temperature to enhance the meltability and formability without reducing the devitrification resistance, and enhances the strain point and Young's modulus. However, when the content of BaO is too large, the density and thermal expansion coefficient increase, the ion exchange performance is reduced, and the component balance of the glass composition is lacked, and thus the glass is likely to be devitrified. The suitable content range of BaO is from 0 to 5%, from 0 to 3%, from 0 to 1%, and in particular from 0 to less than 0.1%, in mol %.

ZnO is a component that enhances the ion exchange performance, and is particularly a component that has a large effect on increasing the compression stress value. It is also a component that reduces the viscosity in high temperature without reducing the viscosity in low temperature. However, when the content of ZnO is too large, there are tendencies that the glass is phase-separated, the devitrification resistance is reduced, the density increases, and the stress depth of the compression stress layer becomes small. Thus, the content of ZnO is preferably from 0 to 6%, from 0 to 5%, from 0 to 1%, from 0 to 0.5%, and in particular from 0 to less than 0.1%, in mol %.

ZrO₂ is a component that significantly enhances the ion exchange performance, and is a component that enhances the viscosity near the liquidus viscosity and the strain point. However, when the content thereof is too large, the devitrification resistance may be significantly reduced, and the density may become too high. Thus, the suitable upper limit range of ZrO₂ is 10% or less, 8% or less, 6% or less, and in particular 5% or less, in mol %. Note that in a case where the ion exchange performance is to be increased, ZrO₂ is preferably introduced into the glass composition. In this case, the suitable lower limit range of ZrO₂ is 0.001% or more, 0.01% or more, 0.5%, and in particular 1% or more.

P₂O₅ is a component that enhances the ion exchange performance, and in particular, is a component that increases the stress depth of the compression stress layer. It is also a component that suppresses the Young's modulus to be low. However, when the content of P₂O₅ is too large, the glass is likely to be phase-separated. Thus, the suitable upper limit range of P₂O₅ is 10% or less, 8% or less, 6% or less, 4% or less, 2% or less, 1% or less, and in particular less than 0.1%, in mol %.

As a fining agent, one type or two or more types selected from the group consisting of As₂O₃, Sb₂O₃, SnO₂, F, Cl, and SO₃ (preferably, the group consisting of SnO₂, Cl, and SO₃) may be introduced in an amount of from 0 to 30000 ppm (3%). The content of SnO₂+SO₃+Cl is preferably from 0 to 10000 ppm, from 50 to 5000 ppm, from 80 to 4000 ppm, from 100 to 3000 ppm, and in particular from 300 to 3000 ppm, from the perspective of adequately exhibiting a fining effect. Here, “SnO₂+SO₃+Cl” indicates a total amount of SnO₂, SO₃, and Cl.

The suitable content range of SnO₂ is from 0 to 10000 ppm, from 0 to 7000 ppm, and in particular from 50 to 6000 ppm. The suitable content range of Cl is from 0 to 1500 ppm, from 0 to 1200 ppm, from 0 to 800 ppm, from 0 to 500 ppm, and in particular from 50 to 300 ppm. The suitable content range of SO₃ is from 0 to 1000 ppm, from 0 to 800 ppm, and in particular from 10 to 500 ppm.

A rare earth oxide such as Nd₂O₃ or La₂O₃ is a component that enhances the Young's modulus, and is also a component that is decolored when a color serving as a complementary color is added, so that the color of the glass can be controlled. However, the cost of the raw material itself is high, and when the rare earth oxide is introduced in a large amount, the devitrification resistance is more likely to decrease. Thus, the content of the rare earth oxide is preferably 4% or less, 3% or less, 2% or less, 1% or less, and in particular 0.5% or less.

In the present invention, from environmental considerations, preferably, As₂O₃, F, PbO, and Bi₂O₃ are not substantially contained. Here, the expression that “As₂O₃ is not substantially contained” has the general meaning that As₂O₃ is not proactively added as a glass component but a case of being mixed at an impurity level is permitted. Specifically, it indicates that the content of As₂O₃ is less than 500 ppm. The expression that “F is not substantially contained” has the general meaning that F is not proactively added as a glass component but a case of being mixed at an impurity level is permitted. Specifically, it indicates that the content of F is less than 500 ppm. The expression that “PbO is not substantially contained” has the general meaning that PbO is not proactively added as a glass component but a case of being mixed at an impurity level is permitted. Specifically, it indicates that the content of PbO is less than 500 ppm. The expression that “Bi₂O₃ is not substantially contained” has the general meaning that Bi₂O₃ is not proactively added as a glass component but a case of being mixed at an impurity level is permitted. Specifically, it indicates that the content of Bi₂O₃ is less than 500 ppm.

As an example, the tempered glass 1 does not contain B₂O₃ in the glass composition, or the content thereof may be limited as being contained in an extremely small amount. That is, the tempered glass 1 may contain, as the glass composition, from 50 to 80% of SiO₂, from 5 to 25% of Al₂O₃, from 0 to 1% of B₂O₃, from 0 to 20% of Li₂O, from 1 to 20% of Na₂O, and from 0 to 10% of K₂O, in mol %.

As another example, the tempered glass 1 may contain B₂O₃ as an essential component in the glass composition. That is, the tempered glass 1 may contain, as the glass composition, from 50 to 80% of SiO₂, from 5 to 25% of Al₂O₃, from 1 to 5% of B₂O₃, from 0 to 20% of Li₂O, from 1 to 20% of Na₂O, and from 0 to 10% of K₂O, in mol %.

Note that in a case where the tempered glass 1 contains B₂O₃ as an essential component in the glass composition, there is a concern that the formability of the glass is reduced, and thus, for example, a content of another component such as Al₂O₃ may be limited for balance. That is, the tempered glass 1 may contain, as the glass composition, from 50 to 80% of SiO₂, from 5 to 10% of Al₂O₃, from 1 to 5% of B₂O₃, from 0 to 20% of Li₂O, from 1 to 20% of Na₂O, and from 0 to 10% of K₂O, in mol %.

### Method for Manufacturing Tempered Glass

The tempered glass 1 is obtained by subjecting a glass for chemical tempering to ion exchange treatment.

First, the glass for chemical tempering is prepared. The glass for chemical tempering is a glass having a shape size and a glass composition that are the same as those of the tempered glass 1 described above.

The glass for chemical tempering is obtained by cutting, into small pieces of glass, a plate-shaped or sheet-shaped mother glass that is obtained by a forming method such as, for example, an overflow downdraw method, a slot downdraw method, a float method, or a redraw method, and processing the small pieces of glass. The overflow downdraw method is preferably used as the forming method to obtain a smooth surface. The small piece of glass that have been cut out are each subjected to processing of forming a recessed groove to form the thin portion 11. The recessed groove is formed by processing such as etching or grinding.

An end surface of the glass for chemical tempering is preferably subjected to chamfering or treatment for improving the strength by polishing, heat treatment, etching, or the like. Although a main surface of the glass for chemical tempering may be polished, for example, in a case where a smooth main surface is formed in advance by the overflow downdraw method, or in a case where the glass having a uniform thickness and good accuracy is formed, the main surface need not be subjected to polishing treatment, that is, the glass having a non-polished surface as is may be used. Note that in a case of being formed by the overflow downdraw method and not being polished, the main surface of the glass for chemical tempering is a forged surface. The glass for chemical tempering may be further subjected to slimming treatment that reduces the thickness by etching. Note that in the present invention, the main surface refers to a front or back surface of the entire surface of the plate-shaped or sheet-shaped glass excluding the end surface.

The glass for chemical tempering obtained as described above is subjected to ion exchange treatment. Specifically, the glass for chemical tempering is immersed in a molten salt for the ion exchange treatment.

The molten salt is a salt including components that can be ion-exchanged with the components in the glass for chemical tempering, and is typically alkali nitrate. Examples of the alkali nitrate include NaNO₃, KNO₃, and LiNO₃, and they can be used alone (at 100 mass %) or a plurality of them can be mixed to be used. The mixing ratio in a case of mixing the plurality of the alkali nitrates may be arbitrarily determined, but can be, for example, from to 95% of NaNO₃ and from 5 to 95% of KNO₃, preferably from 30 to 80% of NaNO₃ and from 20 to 70% of KNO₃, and more preferably from 50 to 70% of NaNO₃ and from 30 to 50% of KNO₃, in mass %.

The conditions such as a temperature of the molten salt and an immersion time in the ion exchange treatment may be set in accordance with the composition and the like in a range where the stress characteristics described above can be obtained, but the temperature of the molten salt is, for example, from 350° C. to 500° C., preferably from 355° C. to 470° C., from 360° C. to 450° C., from 365° C. to 430° C., or from 370° C. to 410° C. Furthermore, the immersion time is, for example, from 3 to 300 minutes, preferably from 5 to 120 minutes, and more preferably from 7 to 100 minutes.

The tempered glass 1 is obtained through the ion exchange treatment described above. After the ion exchange treatment described above, the tempered glass 1 is preferably washed and dried. Furthermore, the tempered glass 1 is preferably protected by affixing a protective film. A protective film of a self-adhering type or a protective film including an adhesive having weak adhesiveness is preferably used to obtain a high surface cleanliness without any adhesive residue after peeling of the protective film.

Note that the tempered glass 1 may be further polished after the ion exchange treatment. In a case where the size, shape, and surface condition of the tempered glass 1 vary due to the ion exchange treatment, these can be modified by polishing. On the other hand, unnecessary microcracks may increase due to the polishing, and thus, in a case where the tempered glass 1 is an unpolished article formed by the overflow downdraw method or the like as described above, and the main surface of the tempered glass 1 after the ion exchange treatment is a smooth non-polished surface (forged surface), it is preferable not to perform polishing. Note that in a case where the tempered glass 1 is formed by the overflow downdraw method, the tempered glass 1 has a formed confluent surface therein.

Furthermore, the tempered glass 1 may be etched after the ion exchange treatment. Specifically, the entire tempered glass 1 is immersed in a liquid etching medium to wet-etch the entire surface of the tempered glass 1. With such treatment, the entire glass can be uniformly etched, and thus occurrence of variation in thickness due to etching can be suppressed. In a case where such etching is performed, the surface of the tempered glass 1 is constituted by an etched surface.

As the etching medium, an acidic or alkaline aqueous solution capable of etching the glass can be used.

As the acidic etching medium, for example, an acidic aqueous solution containing HF can be used. In a case where the aqueous solution containing HF is used, an etching rate for the glass is high, and it is possible to produce the tempered glass 1 with high productivity.

The aqueous solution including HF is, for example, HF only, or an aqueous solution containing a combination of HF and HCl, HF and HNO₃, HF and H₂SO₄, or HF and NH₄F. The concentration of each compound of HF, HCL, HNO₃, H₂SO₄, and NH₄F is preferably from 0.1 to 30 mol/L. In etching using the aqueous solution containing HF, fluoride containing a glass component is produced as a by-product, which can cause a decrease in the etching rate and defects. However, when HF is mixed with another acid such as HCL, HNO₃, or H₂SO₄ to form an acid mixture as described above, the by-product is decomposed, and thus it is possible to suppress reduction in productivity. When etching is performed using the acidic aqueous solution, the temperature of the acidic aqueous solution is, for example, from to 30° C., and the time for which the tempered glass 1 is immersed is preferably from 0.1 to 60 minutes.

As the alkaline etching medium, an alkali aqueous solution containing NaOH or KOH can be used. The alkali aqueous solution has a relatively small etching rate for the glass as compared to the etching medium containing HF described above, and thus there is an advantage that an etching amount is easy to be accurately controlled. In particular, in a case where it is necessary to control the thickness, DOC, and the like of the glass in several μm as in the present invention, the alkali aqueous solution is suitable.

The concentration of the alkali component in an aqueous solution containing NaOH or KOH is preferably from 1 to 20 mol/L. In a case where etching is performed using the alkali aqueous solution, preferably, the temperature of the alkali aqueous solution is, for example, from 10 to 130° C., and the time for which the tempered glass 1 is immersed is, for example, from 0.5 to 120 minutes. Note that in a case where the etching rate is increased to improve productivity, the temperature of the alkali aqueous solution is preferably raised to 80° C. or higher. Conversely, in a case where the etching amount is to be controlled with higher accuracy, it is preferable to limit the temperature of the alkali aqueous solution to 70° C. or lower. Furthermore, in a case where the magnitude of the etching rate is more emphasized, it is preferable to use an aqueous solution of NaOH.

It is preferable to use the etching medium described above to perform etching in such a manner that the etching amount (a reduced amount of the thickness due to etching) on one surface of the tempered glass 1 is 0.25 μm or more and 3 μm or less. The etching amount of the tempered glass 1 is preferably 0.4 μm or more and 2.7 μm or less, more preferably 0.6 μm or more and 2.5 μm or less, and even more preferably 0.8 μm or more and 2.3 μm or less. When the etching amount is set to this range, the amount of variation of the maximum compression stress or the compression stress depth before and after etching is reduced, which facilitates control.

According to the tempered glass 1 described above, the stress characteristics and the thickness dimension thereof are suitably controlled, and the surface defects are further reduced by etching, and thus high bending performance, bending strength, and crushing suppression at the time of breakage can be simultaneously achieved.

Note that in the first embodiment described above, the thin portion 11 is constituted by a residual portion on one main surface side of the tempered glass 1, which is obtained by forming the recessed groove portion on the other main surface side of the tempered glass 1. The thin portion 11 may be configured by forming a recessed groove on both the main surfaces in such a manner that a cross-sectional central portion of the tempered glass 1 remains. According to such a configuration, even when the glass is bended to either the front or back side, it is possible to make it difficult to be broken.

### Second Embodiment

In the first embodiment described above, a case where the tempered glass 1 includes the thin portion 11 and the thick portions 12 has been described as an example, but the tempered glass of the present invention may be entirely constituted by a thin portion. Note that for configurations and processes that are not specified in a second embodiment described below, the same configurations and processes as those of the first embodiment can be applied, and the detailed description thereof is omitted.

FIG. 4 is a cross-sectional schematic view of a tempered glass 2 according to the second embodiment of the present invention. The plan view shape and dimension of the tempered glass 2 are similar to the plan view dimension (FIG. 1) of the tempered glass 1 according to the first embodiment. FIG. 4 is a view illustrating a cross section taken along a long side of the tempered glass 2.

As illustrated in FIG. 4, the tempered glass 2 according to the second embodiment is entirely constituted by a thin portion 21, and has a substantially uniform thickness. Having a substantially uniform thickness in the present invention refers to deviation in glass thickness being ±10% or less. The thickness of the tempered glass 2 is similar to the thickness t1 of the thin portion 11 of the tempered glass 1 according to the first embodiment described above. The stress characteristics and composition of the tempered glass 2 can be configured similarly to the tempered glass 1 according to the first embodiment.

The tempered glass 2 is obtained by subjecting a glass for chemical tempering having similar dimension and shape to ion exchange treatment similar to that of the first embodiment.

The entire surface of the tempered glass 2 of the second embodiment is constituted by the thin portion 21, and thus bending at any location is possible, and thus the degree of freedom of the device design can be improved. In addition, it is not necessary to form a recessed groove, and thus the tempered glass having high bendability and strength can be provided with high productivity.

### Modified Embodiment

In each of the embodiments described above, a case where the shape of the tempered glass has a rectangular shape in plan view has been described as an example, but this is not a limitation, and the shape of the tempered glass of the present invention can be, for example, a shape such as square, circle, or ellipse.

The tempered glass of the present invention may be subjected to three-dimensional bending, as necessary. Specifically, when a glass for chemical tempering is entirely or partially subjected to three-dimensional bending in advance, a three-dimensional bending shape can be imparted to the tempered glass after the ion exchange treatment and the etching.

In each of the embodiments described above, a case where the tempered glass is subjected to ion exchange treatment once has been described as an example, but the tempered glass may be subjected to ion exchange treatment twice, three times, or more. Furthermore, heat treatment may be performed before and after ion exchange. The heat treatment facilitates stress release and ion diffusion, and thus the compression stress layer depth and the like can be controlled.

The tempered glass according to each of the embodiments described above can be used as a laminate by being layered with any plate-shaped or sheet-shaped resin material, a metal material, or a transparent material such as a glass with an adhesive or the like interposed therebetween.

### Examples

The tempered glass according to the present invention will be described below based on examples. Note that the following examples are exemplary only, and the present invention is not limited to the following examples at all.

Samples were produced as follows. First, glasses for ion exchange having the glass compositions described in Table 1 were prepared.

Specifically, glass raw materials were blended as the compositions described in Table 1, and melted in a test melting furnace to obtain molten glasses. Then, the molten glasses obtained were flow-down-formed from a refractory compact using the overflow downdraw method, and cut and processed to obtain glasses for tempering having respective thicknesses described in Tables 2 to 4. Note that the Young's modulus listed in Table 1 indicates a value measured by a resonance method for the glass for tempering of each composition.

The glasses for which the thickness t2 of the thick portion is listed in Tables 2 to 4 are each a glass including the thick portion and the thin portion in the same manner as in the first embodiment described above. In the glass including the thick portion and the thin portion, a plate-shaped sample having a uniform thickness of the thick portion was first produced, and then the thin portion having a band width W of 20 mm was formed by etching. Note that, the glasses for which the thickness t2 of the thick portion is not shown in Tables 2 to 4 are each a glass having a uniform thickness t1, the entire of which is constituted by the thin portion as in the second embodiment described above. Note that the plan view dimension was 50×50 mm for each sample.

Then, each of the glasses for tempering was immersed in a molten salt of 100% KNO₃ at 390° C. for the time described in Tables 2 to 4, and a tempered glass was obtained.

No. 1 to 20, and 23 to 31 in Tables 2 to 4 are examples of the present invention, and No. 21 and 22 are comparative examples.

TABLE 1

| (mol %) | A | B | C | D | E | F | G | H | I |
|---|---|---|---|---|---|---|---|---|---|
| SiO₂ | 66.4 | 63.5 | 61.0 | 67.6 | 57.0 | 62.5 | 69.9 | 68.6 | 67.1 |
| Al₂O₃ | 11.5 | 17.3 | 19.8 | 11.1 | 16.3 | 14.8 | 8.67 | 10.3 | 12.7 |
| MgO | 4.8 | — | — | 3.9 | 2.7 | 3.4 | 4.7 | 5.6 | 2.4 |
| CaO | 0.1 | — | — | — | — | — | 0.1 | — | — |
| B₂O₃ | 0.5 | — | — | — | — | 1.8 | 2.3 | — | 3.8 |
| ZnO | — | 1.2 | 1.2 | — | — | — | — | — | — |
| ZrO₂ | — | — | — | 0.5 | — | — | — | — | — |
| Li₂O | 0.02 | 4.3 | 8.3 | — | — | 0.02 | 0.03 | — | — |
| Na₂O | 15.2 | 13.1 | 7.1 | 15.5 | 17.2 | 17.3 | 13.7 | 15.3 | 13.9 |
| K₂O | 1.4 | — | — | 1.3 | — | 0.1 | 0.45 | — | — |
| P₂O₅ | — | 0.5 | 2.5 | — | 6.7 | — | — | — | — |
| SnO₂ | 0.1 | 0.1 | 0.1 | 0.1 | 0.1 | 0.1 | 0.15 | 0.2 | 0.1 |
| Young's | 72.1 | 77.5 | 80.6 | 71.6 | 64.4 | 71.0 | 70.1 | 70.0 | 66.0 |
| modulus (GPa) | | | | | | | | | |

TABLE 2

| No. | | 1 | 2 | 3 | 4 | 5 | 6 | 7 | 8 | 9 | 10 | 11 |
|---|---|---|---|---|---|---|---|---|---|---|---|---|
| Composition | | A | A | A | A | A | A | A | A | A | A | A |
| t1 | μm | 35 | 35 | 35 | 35 | 35 | 50 | 50 | 50 | 50 | 50 | 50 |
| t2 | μm | — | — | — | — | — | — | — | — | — | 200 | — |
| Ion exchange | min | 8 | 15 | 30 | 45 | 90 | 8 | 15 | 30 | 45 | 60 | 90 |
| time | | | | | | | | | | | | |
| CS | MPa | 863 | 789 | 699 | 668 | 540 | 899 | 941 | 837 | 784 | 745 | 688 |
| DOC | μm | 2.7 | 3.2 | 2.7 | 2.4 | 3.2 | 4.0 | 4.1 | 4.1 | 4.6 | 4.7 | 4.5 |
| CT | MPa | — | 93 | 68 | 55 | 62 | — | 95 | 86 | 93 | 90 | 79 |
| CS/DOC | MPa/μm | 320 | 247 | 259 | 278 | 171 | 225 | 230 | 204 | 171 | 159 | 153 |
| DOC/t1 | | 0.077 | 0.091 | 0.077 | 0.069 | 0.090 | 0.080 | 0.082 | 0.082 | 0.092 | 0.094 | 0.090 |
| DCT | μm | — | 3.6 | 3.0 | 2.6 | 3.5 | — | 4.5 | 4.5 | 5.1 | 5.3 | 5.0 |
| DCT/t1 | | — | 0.102 | 0.085 | 0.074 | 0.100 | — | 0.090 | 0.090 | 0.103 | 0.105 | 0.100 |
| Numbers of | Piece | 6 | 2 | 10 | 4 | 5 | 0 | 5 | 7 | 4 | 60 | 3 |
| broken fragments | | | | | | | | | | | | |
| in pen-drop test | | | | | | | | | | | | |
| Pen-drop fracture | cm | — | — | — | — | — | — | — | — | — | — | — |
| height | | | | | | | | | | | | |
| Fracture bending | mm | — | — | — | — | — | — | — | — | — | — | — |
| radius | | | | | | | | | | | | |

TABLE 3

| No. | | 12 | 13 | 14 | 15 | 16 | 17 | 18 | 19 | 20 | 21 | 22 |
|---|---|---|---|---|---|---|---|---|---|---|---|---|
| Composition | | A | A | A | A | A | A | A | A | A | A | A |
| t1 | μm | 50 | 50 | 70 | 70 | 70 | 100 | 100 | 100 | 100 | 100 | 100 |
| t2 | μm | — | — | — | — | — | — | — | — | — | — | — |
| Ion exchange | min | 135 | 180 | 15 | 45 | 60 | 15 | 30 | 45 | 60 | 135 | 180 |
| time | | | | | | | | | | | | |
| CS | MPa | 640 | 555 | 893 | 817 | 811 | 919 | 945 | 917 | 879 | 816 | 813 |
| DOC | μm | 4.0 | 3.9 | 4.4 | 5.8 | 6.1 | 4.9 | 5.9 | 7.0 | 7.9 | 9.3 | 9.3 |
| CT | MPa | 63 | 53 | 67 | 87 | 92 | 51 | 67 | 76 | 85 | 98 | 97 |
| CS/DOC | MPa/μm | 160 | 142 | 203 | 141 | 133 | 187 | 160 | 131 | 111 | 88 | 87 |
| DOC/t1 | | 0.080 | 0.078 | 0.063 | 0.083 | 0.087 | 0.049 | 0.059 | 0.070 | 0.079 | 0.093 | 0.093 |
| DCT | μm | 4.4 | 4.3 | 4.7 | 6.4 | 6.8 | 5.2 | 6.3 | 7.6 | 8.7 | 10.4 | 10.4 |
| DCT/t1 | | 0.088 | 0.085 | 0.068 | 0.092 | 0.097 | 0.052 | 0.063 | 0.076 | 0.087 | 0.104 | 0.104 |
| Numbers of | Piece | 3 | 3 | 4 | 8 | 8 | 7 | 10 | 7 | 12 | 370 | 10000 |
| broken fragments | | | | | | | | | | | | |
| in pen-drop test | | | | | | | | | | | | |
| Pen-drop fracture | cm | — | — | — | — | — | — | — | — | — | — | — |
| height | | | | | | | | | | | | |
| Fracture bending | mm | — | — | — | — | — | — | — | — | — | — | — |
| radius | | | | | | | | | | | | |

TABLE 4

| No. | | 23 | 24 | 25 | 26 | 27 | 28 | 29 | 30 | 31 |
|---|---|---|---|---|---|---|---|---|---|---|
| Composition | | A | B | C | D | E | F | G | H | I |
| t1 | μm | 50 | 50 | 50 | 50 | 50 | 50 | 50 | 47 | 45 |
| 12 | μm | — | — | — | — | — | — | — | — | — |
| Ion exchange | min | 48 | 78 | 225 | 37 | 15 | 46 | 60 | 51 | 42 |
| time | | | | | | | | | | |
| CS | MPa | 891 | 1299 | 1098 | 882 | 832 | 1173 | 741 | 685 | 607 |
| DOC | μm | 7.4 | 7.1 | 6.4 | 7.1 | 6.3 | 6.8 | 7.4 | 7.1 | 6.0 |
| CT | MPa | 120 | 153 | 81 | 124 | 92 | 148 | 76 | 95 | 86 |
| CS/DOC | MPa/μm | 121 | 184 | 172 | 125 | 131 | 172 | 100 | 96 | 101 |
| DOC/t1 | | 0.147 | 0.141 | 0.128 | 0.141 | 0.127 | 0.136 | 0.148 | 0.151 | 0.134 |
| DCT | μm | 8.3 | 7.9 | 6.9 | 8.1 | 7.0 | 7.7 | 8.1 | 8.1 | 6.9 |
| DCT/t1 | | 0.167 | 0.158 | 0.137 | 0.161 | 0.141 | 0.154 | 0.163 | 0.172 | 0.153 |
| Numbers of | Piece | 25 | — | 18 | 22 | 15 | — | 16 | — | — |
| broken fragments | | | | | | | | | | |
| in pen-drop test | | | | | | | | | | |
| Pen-drop fracture | cm | 7 | 3 | 4 | 5 | 1 | 3 | 10 | — | — |
| height | | | | | | | | | | |
| Fracture bending | mm | 1.6 | 1.6 | 1.7 | 1.9 | 1.8 | 1.6 | 1.5 | — | — |
| radius | | | | | | | | | | |

The maximum compression stress CS, the depth DOC of the compression stress, and the tensile stress CT in Tables 2 to 4 are values measured in the thin portion of each sample using a surface stress meter FSM-6000LE available from Orihara Industrial Co., Ltd. More specifically, DOC is DOL_zero measured using FSM-6000LE, and CT is a value of CT_CV measured using FSM-6000LE.

In addition, a pen-drop test was performed for each sample. Specifically, a glass sample was placed on a stone surface plate, a pen tip of a ball-point pen having a ball diameter of 0.7 mm and a mass of 5.4 g (available from BIC Japan, orange EG0.7) was vertically dropped onto the center of the glass sample to perform the test. The height of the pen tip end before dropping was defined as a drop height, the initial value thereof was set to 1 cm, and the pen tip was dropped. In a case where the glass sample was not broken due to the dropping, the height was increased by 1 cm and the pen tip was dropped again. In this manner, a trial of increasing the drop height and dropping was repeated until the glass sample was broken, and the drop height when the glass sample was broken was determined as the pen-drop fracture height. Note that the glass sample was replaced with a new sample every time the pen was dropped. Furthermore, the number of broken glass fragments was counted. Note that minute fragments are difficult to count, and thus the count target is limited to that having the maximum outer diameter of 0.1 mm or greater. Note that the glass sample having the thick portion and the thin portion was placed in such a manner that the flat surface was lower (the recessed groove portion was upper), and the pen tip was dropped onto the thin portion to perform the test.

Furthermore, the bending fracture test was performed on each of the glass samples described above to determine the fracture bending radius. Specifically, the glass sample was installed in such a manner that between two SUS plates disposed vertically in a universal tester Autograph AG-X available from Shimadzu Corporation, two short sides of the glass sample were in contact with the respective SUS plates, and a load was applied so that the central portion of the long side of the glass sample was curved and deformed. While the bending radius was measured, the load was gradually increased until the glass sample was broken. The bending radius immediately before the glass sample was broken was determined as a fracture bending radius. Note that the dimension of the glass sample in the bending fracture test was 130×20 mm.

According to the results of the pen-drop test described above, the numbers of fragments of the glass samples according to the examples were suppressed as compared to the comparative examples, and it was confirmed that crushing was suppressed.

### INDUSTRIAL APPLICABILITY

The tempered glass of the present invention can be used for, for example, a smartphone, a mobile phone, a tablet computer, a personal computer, a digital camera, a touch panel display, cover glasses for other display devices, a vehicle-mounted display device, a vehicle-mounted panel, and the like.

### REFERENCE SIGNS LIST

1, 2 Tempered glass
11, 21 Thin portion
12 Thick portion

1. A tempered glass having a plate shape or a sheet shape, the tempered glass comprising:
a compression stress layer on a surface of the tempered glass; and
a tensile stress layer on an inner side in a thickness direction of the tempered glass with respect to the compression stress layer, wherein
the tempered glass includes at least partially a thin portion having a thickness t1 and being bendable,
the thickness t1 is 105 μm or less,
a depth DOC of the compression stress layer is 9.0 μm or less, and
when a maximum compression stress of the compression stress layer is defined as CS, CS/DOC≥95 is satisfied.

2. The tempered glass according to claim 1, wherein
the thickness t1 is 20 μm or greater and 95 μm or less,
the maximum compression stress CS of the compression stress layer is 550 MPa or greater and 1600 MPa or less, and
the depth DOC of the compression stress layer is 1.0 μm or greater and 8.5 μm or less.

3. The tempered glass according to claim 1, wherein
the maximum compression stress CS of the compression stress layer and the depth DOC of the compression stress layer satisfy
CS/DOC≥110.

4. The tempered glass according to claim 1, wherein a maximum tensile stress CT of the tensile stress layer in the thin portion is 95 MPa or less.

5. The tempered glass according to claim 1, wherein
a ratio of the depth DOC of the compression stress layer to the thickness t1 satisfies DOC/t1≤0.09.

6. The tempered glass according to claim 1, wherein
the tensile stress layer includes
a first region extending from the depth DOC of the compression stress layer to a tensile stress convergence depth DCT, in which a tensile stress varies in the thickness direction of the tempered glass, and
a second region extending in a region deeper than the tensile stress convergence depth DCT, in which the tensile stress is constant in the thickness direction,
the tensile stress convergence depth DCT is 10.0 μm or less, and
DCT/t1≤0.10 is satisfied.

7. The tempered glass according to claim 1, further comprising
a plurality of thick portions having a thickness t2 greater than the thickness t1 of the thin portion, wherein
the thickness t2 is 110 μm or greater and 300 μm or less, and
the thin portion extends in a band shape to connect the plurality of thick portions.

8. The tempered glass according to claim 7, wherein a band width of the thin portion is 3 mm or greater.

9. The tempered glass according to claim 1, wherein the tempered glass is entirely constituted by the thin portion and has a substantially uniform thickness.

10. The tempered glass according to claim 1, containing, as a glass composition, in mol %, from 50 to 80% of SiO₂, from 5 to 25% of Al₂O₃, from 0 to 15% of B₂O₃, from 0 to 20% of Li₂O, from 1 to 20% of Na₂O, and from 0 to 10% of K₂O.

11. The tempered glass according to claim 10, containing, as the glass composition, in mol %, from 50 to 80% of SiO₂, from 5 to 25% of Al₂O₃, from 0 to 1% of B₂O₃, from 0 to 20% of Li₂O, from 1 to 20% of Na₂O, and from 0 to 10% of K₂O.

12. The tempered glass according to claim 10, containing, as the glass composition, in mol %, from 50 to 80% of SiO₂, from 5 to 25% of Al₂O₃, from 1 to 5% of B₂O₃, from 0 to 20% of Li₂O, from 1 to 20% of Na₂O, and from 0 to 10% of K₂O.

13. The tempered glass according to claim 12, containing, as the glass composition, in mol %, from 50 to 80% of SiO₂, from 5 to 10% of Al₂O₃, from 1 to 5% of B₂O₃, from 0 to 20% of Li₂O, from 1 to 20% of Na₂O, and from 0 to 10% of K₂O.

14. The tempered glass according to claim 1, wherein an entire surface is constituted by an etched surface.

15. A tempered glass having a plate shape or a sheet shape, the tempered glass comprising:
a compression stress layer on a surface of the tempered glass; and
a tensile stress layer on an inner side in a thickness direction of the tempered glass with respect to the compression stress layer, wherein
the tempered glass includes at least partially a thin portion having a thickness t1 and being bendable,
the thickness t1 is 105 μm or less,
a depth DOC of the compression stress layer is 9.0 μm or less, and
when a maximum compression stress of the compression stress layer is defined as CS, CS/DOC≥110 is satisfied.
